(19) United States
(12) Patent Application Publication
(10) Pub. No.: US 2017/0043667 A1
(43) Pub. Date: Feb. 16, 2017

(54) SYSTEM AND METHOD FOR CONTROLLING A CYCLING EQUIPMENT, AND BICYCLE

(71) Applicants: LE HOLDINGS (BEIJING) CO., LTD., Beijing (CN); LETV SPORTS CULTURE DEVELOP (BEIJING) CO., LTD., Beijing (CN)

(72) Inventor: Dalong LI, Beijing (CN)

(21) Appl. No.: 15/236,925

(22) Filed: Aug. 15, 2016

Related U.S. Application Data
(63) Continuation of application No. PCT/CN2016/082053, filed on May 13, 2016.

(30) Foreign Application Priority Data
Aug. 11, 2015 (CN) 201510491097.5

(51) Int. Cl. B60L 11/14; H02K 7/18; B62M 6/50

(52) U.S. Cl. CPC B60L 11/14; B62M 6/50; H02K 7/1846; B60L 2200/12; B60L 2240/52; B60L 2240/642

(57) ABSTRACT

The present disclosure provides a system and method for controlling a cycling equipment, and a bicycle so as to improve the utilization ratio of energy. The system and method for controlling a cycling equipment includes: an energy converting module configured to convert mechanical energy into electric energy; and a controller connected with the energy converting module, configured to determine an uphill or downhill traveling state of the cycling equipment, and to control the energy converting module to or not to convert the mechanical energy generated by the cycling equipment into the electric energy, according to the determined uphill or downhill traveling state of the cycling equipment.

### CROSS REFERENCE TO RELATED APPLICATIONS

This application is a continuation of International Application No. PCT/CN2016/082053, filed on May 13, 2016, which is based upon and claims priority to Chinese Patent Application No. 201510491097.5, filed on Aug. 11, 2015, the entire contents of which are incorporated herein by reference,

### TECHNICAL FIELD

The present disclosure relates to the field of intelligent control technologies, and particularly to a system and method for controlling a cycling equipment, and a bicycle.

### BACKGROUND

Bicycles and other such cycling equipments have become indispensable transportation means of people due to their low carbon, environment-conserving, economy, convenience, and other advantages. Such cycling equipments generally generate a lot of mechanical energy while traveling, which has been not utilized effectively but wasted in the prior art.

### SUMMARY

The present disclosure provides a system and method for controlling a cycling equipment, and a bicycle,

An embodiment of the disclosure provides a system for controlling a cycling equipment, the system including:

an energy converting module configured to convert mechanical energy into electric energy; and

a controller connected with the energy converting module, configured to determine an uphill or downhill traveling state of the cycling equipment, and to control the energy converting module to or not to convert the mechanical energy generated by the cycling equipment into the electric energy, according to the determined uphill or downhill traveling stale of the cycling equipment.

An embodiment of the disclosure provides a bicycle including the controlling system described above.

An embodiment of the disclosure provides a method for controlling a cycling equipment, the method including:

determining an uphill or downhill traveling state of the cycling equipment; and

determining whether to convert mechanical energy generated by the cycling equipment into electric energy, according to the determined uphill or downhill traveling state of the cycling equipment.

With the system and method for controlling a cycling equipment, and the bicycle according to the embodiments of the disclosure, it can he determined from the uphill or downhill traveling state of the cycling equipment whether to convert the mechanical energy generated by the cycling equipment into the electric energy to thereby utilize the mechanical energy; so that the mechanical energy generated by the cycling equipment while traveling can be utilized reasonably to thereby improve the utilization ratio of the energy.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a first schematic structural diagram of a system for controlling a cycling equipment according to some embodiments;

FIG. 2 is a second schematic structural diagram of a system for controlling a cycling equipment according to some embodiments;

FIG. 3 is a schematic structural diagram of an energy converting modulo in the system for couponing a cycling equipment according to some embodiments;

FIG. 4 is a third schematic structural diagram of a system for controlling a cycling equipment according to some embodiments; and

FIG. 5 is a schematic flow chart of a method for controlling a cycling equipment according to some embodiments.

### DETAILED DESCRIPTION OF THE EMBODIMENTS

In order to make the objects, technical solutions, and advantages of the embodiments of the disclosure more apparent the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

As illustrated, a system for controlling a cycling equipment according to an embodiment of the disclosure includes:

An energy converting module 101 is configured to convert mechanical energy into electric energy; and

A controller 100 connected with the energy converting module 101 is configured to determine an uphill or downhill traveling state of the cycling equipment, and to control the energy converting module 101 to or not to convert the mechanical energy generated by the cycling equipment into the electric energy, according to the determined uphill or downhill traveling state of the cycling equipment.

Furthermore the controller 100 is configured to control the energy converting module 101 to convert the mechanical energy generated by the cycling equipment into the electric energy, upon determining the downhill traveling state of the cycling equipment, and to control the energy converting module 101 not to convert the mechanical energy generated by the cycling equipment into the electric energy, upon determining a state other than the downhill traveling state of the cycling equipment.

If the cycling equipment is in the downhill traveling state, then the cycling equipment will be traveling at a higher speed, and its rider will lower the traveling speed of the cycling equipment by braking, thus consuming the mechanical energy, so if the cycling equipment is in the downhill traveling state, then the mechanical energy generated by the cycling equipment will be converted into the electric energy to thereby be utilized; and if the cycling equipment is not in the downhill traveling state, then the mechanical energy generated by the cycling equipment will not be converted into the electric energy, so that the riding load of the rider will not be increased.

As can be apparent, with the system tor controlling a cycling equipment according to the embodiment of the disclosure, it can be determined from the uphill or downhill traveling state of the cycling equipment whether to convert the mechanical energy generated by (he cycling equipment into the electric energy to thereby utilize the mechanical energy, so that the mechanical energy generated by the cycling equipment while traveling can be utilized reasonably to thereby improve the utilization ratio of the energy.

The controlling system according to the embodiment of the disclosure can be applied to a bicycle, a manpower tricycle, and other cycling equipment.

In a particular embodiment of the disclosure, the rider of the cycling equipment can input a traveling stale indicating message to the controller through a button, a dial switch, etc., where the traveling state indicating message can include a downhill state indicating message and a non-downhill state indicating message, that is, if the cycling equipment is in the downhill traveling state, the rider of the cycling equipment will input the downhill state indicating message to the controller 100, and if the cycling equipment is in other than the downhill traveling state, the rider of the cycling equipment will input the non-downhill state indicating message to the controller 100. The controller can determine from the received traveling state indicating message the uphill or downhill traveling state of the cycling equipment. That is, if the controller 100 receives the downhill state indicating message, then the controller will determine the downhill traveling state of the cycling equipment, and control the energy converting module 101 to convert the mechanical energy generated by the cycling equipment into the electric energy; and if the controller 100 receives the non-downhill state indicating message, then the controller will determine other than the downhill traveling state of the cycling equipment, and control the energy converting module 101 not to convert the mechanical energy generated by the cycling equipment into the electric energy.

In another particular embodiment of the disclosure, the uphill or downhill traveling state of the cycling equipment, can be determined without manual participation by the rider.

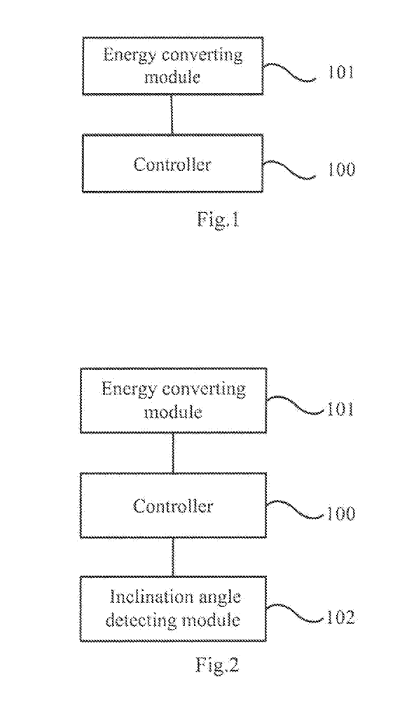

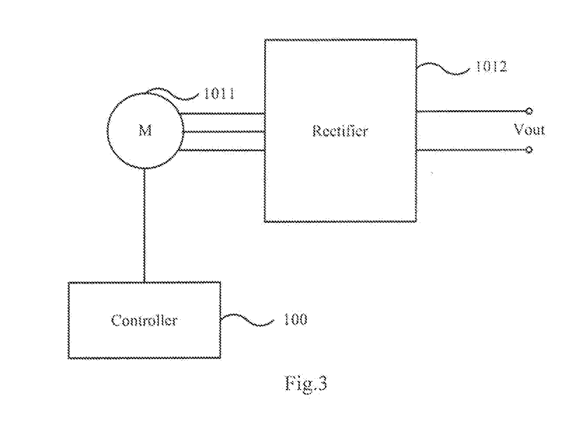

As illustrated in FIG. 2, for example, the system for controlling a cycling equipment particularly includes the energy converting module 101, the controller 100, and an inclination angle detecting module 102, where:

The inclination angle detecting module 102 is configured to detect a forward inclination angle of the cycling equipment while traveling, where the forward inclination refers, to the front of the cycling equipment being lower than the rear thereof, and the forward inclination angle refers to the angle between the cycling equipment and the horizontal level if the cycling equipment is inclined forwarded while traveling.

At this time, the controller 100 is configured to obtain the forward inclination angle detected by the inclination angle detecting module 102; to determine from the forward inclination angle the uphill or downhill traveling state of the cycling equipment; and if the forward inclination angle reaches a preset inclination angle, to determine the downhill traveling state of the cycling equipment, and to control the energy converting module 101 to convert the mechanical energy generated by the cycling equipment into the electric energy, and if the forward inclination angle does not reaches the preset inclination angle, to determine other than the downhill traveling state of the cycling equipment, and to control the energy converting module 101 not to convert the mechanical energy generated by the cycling equipment into the electric energy.

In a real implementation, the forward inclination angle above can also be preset taking into account a particular condition of the cycling equipment a particular condition of a road on which it is traveling, and other respective factors, in combination with historical empirical data, and the embodiment of the disclosure will not be limited to any particular forward inclination angle, for example, the inclination angle can be preset to 5 degrees.

Here the inclination angle detecting module 102 can be but will, not be 1 invited to a gyroscope, or another inclination detector.

In another particular embodiment of the disclosure, the control system can alternatively determine otherwise the uphill or downhill traveling state of the cycling equipment, although a detailed description thereof has been omitted here.

The controller 100 in the system tor controlling a cycling equipment illustrated in FIG. 1 and FIG. 2 can particularly be but will not be limited to a monolithic processor, a Micro Control Unit (MCU), or another controller.

In an embodiment of the disclosure, the energy converting module 101 can be particularly embodied variously, and as illustrated in FIG. 3, for example, it can include:

A power generator 1011 is configured to convert the mechanical energy generated by wheel hub of the cycling equipment into alternating current electric energy; and

A rectifier 1012 is configured to convert the alternating current electric energy generated by the power generator as a result of conversion into direct current electric energy.

Particularly the controller 100 controls the power generator 1011 to start to convert the energy, upon determining the downhill traveling state of the cycling equipment, so that the energy converting module 101 converts the mechanical energy generated by the cycling equipment into the electric energy; and controls the power generator 1011 to be stopped, upon determining other than the downhill traveling state of the cycling equipment, so that the energy converting module 101 will not convert the mechanical energy generated by the cycling equipment into the electric energy.

In a particular implementation, the wheel hubs of the cycling equipment can be connected with a rotator of the power generator 1011 through a chain, a gear wheel, or another mechanical transmission component, where the rotating wheel hubs can bring the rotator of the power generator 1011 into rotation to thereby convert the mechanical energy into the electric energy.

The rectifier 1012 can be embodied particularly as any one of rectifiers in the prior art,

Of course, the energy converting module 101 can alternatively be embodied as another energy converting circuit, and the energy can be converted by another component, of the cycling equipment instead of the wheel hubs of the cycling equipment, although a detailed description thereof has been omitted here.

A power consuming unit in the cycling equipment can be powered by the electric energy generated by the energy converting module 101 as a result of conversion, e.g., a nighttime traveling indicating lamp of the cycling equipment, where the nighttime traveling indicating lamp is typically powered by an accumulator, and if charges in the accumulator are insufficient, then the accumulator will he removed manually and charged, so if the accumulator of the nighttime traveling indicating lamp is charged by the electric energy generated by the energy converting module 101 as a result of conversion, then the energy can be saved, and also the rider will feel very convenient.

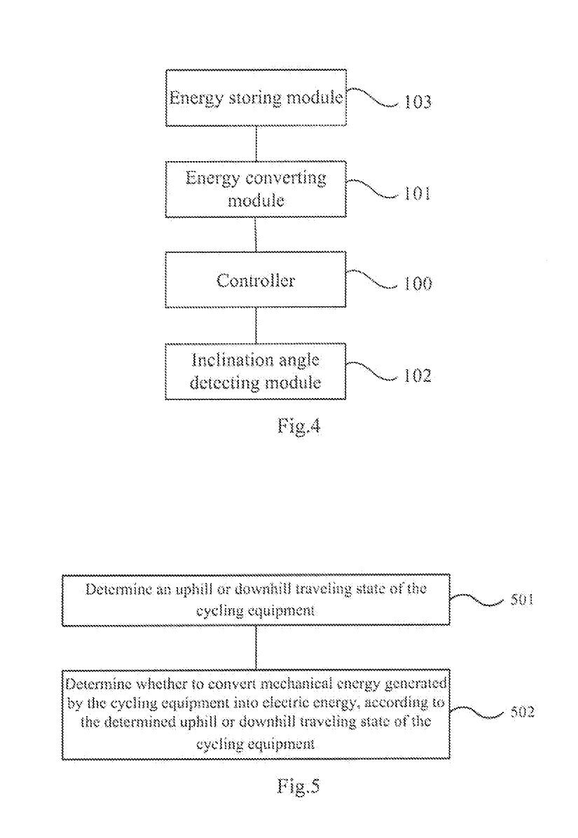

Furthermore the system for controlling a cycling equipment according to any one of the embodiments above of the disclosure can further include an energy storing module 103 as illustrated in FIG. 4, which is connected with the energy converting module 101, and configured to store the electric energy generated by the energy converting module 101 as a result of conversion.

Preferably the energy storing module 103 can be arranged with a powering interface via which a device external to the cycling equipment is powered. Preferably the powering interface is particularly a Universal Serial Bus (USB) interface. Today, daily life and working of people have become increasingly dependent upon various mobile portal devices, e.g., a mobile phone, a tablet computer, a digital camera, etc., all of which are provided with powering interfaces which are USB interfaces, so the USB interface is arranged on the energy storing module 103 as the powering interface of the mobile portable device, and the mobile portable device is powered by the electric energy stored in the energy storing module 103 in a convenient and environment-conserving manner to thereby improve the experience of the user.

Of course, a power consuming unit in the cycling equipment can also be powered by the electric energy stored in, the energy storing module 103.

Furthermore the energy storing module 103 can farther include an inverter configured to convert the stored direct current electric energy into the alternating current electric energy; and at this time, the energy storing module 103 can be arranged with an alternating current powering interface via which an alternating current device is powered, in addition to the direct current powering interface which is the USB interface via which a direct current device is powered.

Preferably the control system can further include a displaying module configured to display an operating state of the energy converting module 101, the amount of remaining charges in the energy storing module 103, and other information to thereby further improve the experience of the user.

As can be apparent, with the system, for controlling a cycling equipment according to the embodiments of the disclosure, the energy can be saved to thereby improve the utilization ratio of the energy, and also the rider will feel convenient.

An embodiment of the disclosure further provides a bicycle including the system for controlling a cycling equipment according to any one of the embodiments above of the disclosure.

Based upon the same inventive idea, an embodiment of the disclosure further provides a method for controlling a cycling equipment as illustrated in FIG. 5, which can include the following operations:

The operation 501 is to determine an uphill or downhill traveling state of the cycling equipment; and

The operation 502 is to determine whether to convert mechanical energy generated by the cycling equipment into electric energy, according to the determined uphill or downhill traveling stale of the cycling equipment.

Furthermore determining whether to convert the mechanical energy generated by the cycling equipment into the electric energy, according to the determined uphill or downhill traveling stale of the cycling equipment in the operation 502 includes:

Determining to convert the mechanical energy generated by the cycling equipment into the electric energy, upon determining that the cycling equipment is in the downhill traveling state, and determining not to convert the mechanical energy generated by the cycling equipment into the electric energy, upon determining that the cycling equipment is in a state other than the downhill traveling state.

The controlling method according to the embodiment, of the disclosure can be applied to a bicycle, a manpower tricycle, and other cycling equipment.

In a particular embodiment of the disclosure, determining the uphill or downhill traveling state of the cycling equipment in the operation 501 includes:

Determining that the cycling equipment is in the downhill traveling state upon reception of a downhill state indicating message; and determining that of the cycling equipment is in a state other than the downhill traveling state upon reception of a non-downhill state indicating message.

In another particular embodiment of the disclosure, determining the uphill or downhill traveling state of the cycling equipment in the operation 501 includes:

Obtaining a forward inclination angle of the cycling equipment while traveling; if the forward inclination angle reaches a preset inclination angle, then determining that the cycling equipment is in the downhill traveling state; and if the forward inclination angle does not reach the preset inclination angle, then determining that the cycling equipment is in a state other than the downhill traveling state, where the forward inclination refers to the front of the cycling equipment being lower than the rear thereof, and the forward inclination angle refers to the angle between the cycling equipment and the horizontal level if the cycling equipment is inclined forwarded while traveling.

In a real implementation, the forward inclination angle above can also be preset taking Into account a particular condition of the cycling equipment, a particular condition of a road on which it is traveling, and other respective factors, in combination with historical empirical data, and the embodiment of the disclosure will not he limited to any particular forward inclination angle, for example, the inclination angle can be preset to 5 degrees.

It shall be noted that in another particular embodiment of the disclosure, the uphill or downhill traveling state of the cycling equipment can alternatively be determined otherwise in the operation 501, although a detailed description thereof has been omitted here.

Both a power consuming unit in the cycling equipment and a mobile portable device, e.g., a mobile phone, etc., can be powered by the electric energy generated as a result of conversion.

In summary, with the technical solutions according to the embodiments of the disclosure, the mechanical energy generated by the cycling equipment while traveling can be utilized reasonably to thereby improve the experience of the rider.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those skilled in the art can appreciate that the respective embodiments described above can be performed by software combined with universal hardware platform, of course they can also be performed by hardware. In this case, the technical solution above in nature or a part of the technical solution that contributed to the existing technology can be embodied in the form of a software product, where the software product, including a number of instructions to enable a computer equipment (including a personal computer, a server, or a network equipment, etc.) to perform the methods in the respective embodiments or in a part of the respective embodiments, can be stored in a computer readable storage medium, for example a ROM/RAM, a magnetic disc, an optical disk, etc..

Lastly it shall be noted that the respective embodiments above are merely intended to illustrate but not to limit the technical solution of the disclosure; and although the disclosure has been described above In details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A system for controlling a cycling equipment the system comprising:
an energy converting module configured to convert mechanical energy into electric energy; and
a controller connected with the energy converting module, configured to determine an uphill or downhill traveling state of the cycling equipment, and to control the energy converting module to or not to convert the mechanical energy generated by the cycling equipment into the electric energy, according to the determined uphill or downhill traveling state of the cycling equipment.

2. The controlling system according to claim 1, wherein the controller is configured to control the energy converting module to convert the mechanical energy generated by the cycling equipment into the electric energy, upon determining that the cycling equipment is in the downhill traveling state, and to control the energy converting module not to convert the mechanical energy generated by the cycling equipment into the electric energy, upon determining that the cycling equipment is in a state other than the downhill traveling state.

3. The controlling system according to claim 1, wherein the controller is configured to determine that, the cycling equipment is in the downhill traveling state upon reception of a downhill state indicating message; and to determine that the cycling equipment is in a state other than the downhill traveling state upon reception of a non-downhill state indicating message.

4. The controlling system according to claim 1, wherein the system further comprises:
an inclination angle detecting module configured to detect a forward inclination angle of the cycling equipment while traveling; and
the controller is configured to obtain the forward inclination angle detected by the inclination angle detecting module; if the forward inclination angle reaches a preset inclination angle, to determine that the cycling equipment is in the downhill traveling state; and if the forward inclination angle does not reaches the preset inclination angle, to determine that the cycling equipment is in a state other than the downhill traveling state.

5. The controlling system according to claim 1, wherein the energy converting module comprises:
a power generator configured to convert the mechanical energy generated by wheel hubs of the cycling equipment into the electric energy; and
a rectifier configured to convert the electric energy generated by the power generator as a result of conversion into direct current electric energy.

6. The controlling system according to claim 1, wherein the system further comprises:
an energy storing module connected with the energy converting module, configured to store the electric energy generated by the energy converting module as a result of conversion.

7. The controlling system according to claim 6, wherein the energy storing module is arranged with a powering interface via which a device external to the cycling equipment is powered.

8. The controlling system according to claim 7, wherein the powering interface is a Universal Serial Bus (USB) interface.

9. A bicycle, comprising a controlling system, wherein the system comprising;
an energy converting module configured to convert mechanical energy into electric energy; and
a controller connected with the energy converting module, configured to determine an uphill or downhill traveling state of the cycling equipment, and to control the energy converting module to or not to convert the mechanical energy generated by the cycling equipment into the electric energy, according to the determined uphill or downhill traveling state of the cycling equipment.

10. The bicycle according to claim 9, wherein the controller is configured to control the energy converting module to convert the mechanical energy generated by the cycling equipment into the electric energy, upon determining that the cycling equipment is in the downhill traveling state, and to control the energy converting module not to convert the mechanical energy generated by the cycling equipment into the electric energy, upon determining that the cycling equipment is in a state other than the downhill traveling state.

11. The bicycle according to claim 9, wherein the controller is configured to determine that the cycling equipment is in the downhill traveling state upon reception of a downhill state indicating message; and to determine that the cycling equipment is in a state other than the downhill traveling state open reception of a non-downhill state indicating message.

12. The bicycle according to claim 9, wherein the system further comprises:
an inclination angle detecting module configured to detect a forward inclination angle of the cycling equipment while traveling; and
the controller is configured to obtain the forward inclination angle detected by the inclination angle detecting module; if the forward inclination angle reaches a preset inclination angle, to determine that the cycling equipment is in the downhill traveling state; and if the forward inclination angle does not reaches the preset inclination angle, to determine that the cycling equipment is in a state other than the downhill traveling state.

13. The bicycle according to claim 9, wherein the energy converting module comprises;
a power generator configured to convert the mechanical energy generated by wheel hubs of the cycling equipment into the electric energy; and
a rectifier configured to convert the electric energy generated by the power generator as a result of conversion into direct current electric energy.

14. The bicycle according to claim 9, wherein the system further comprises:
an energy storing module connected with the energy converting module, configured to store the electric energy generated by the energy converting module as a result of conversion.

15. A method for controlling a cycling equipment, the method comprising:
determining an uphill or downhill travelling of the cycling equipment; and
determining whether to convert mechanical energy generated by the cycling equipment into electric energy, according to the determined uphill or downhill traveling state of the cycling equipment.

16. The controlling method according to claim 15, wherein determining whether to convert the mechanical energy generated by the cycling equipment into the electric energy, according to the determined uphill or downhill traveling state of the cycling equipment comprises:
determining to convert the mechanical energy generated by the cycling equipment into the electric energy, upon determining that the cycling equipment is in the downhill traveling state, and
determining not to convert the mechanical energy generated by the cycling equipment into the electric energy, upon determining that the cycling equipment is in a state other than the downhill traveling state.

17. The controlling method according to claim 15, wherein determining the uphill or downhill traveling state of the cycling equipment comprises:
determining that the cycling equipment is in the downhill traveling state upon reception of a downhill state indicating message; and
determining that the cycling equipment is in state other than the downhill traveling state upon reception of a non-downhill state indicating message.

18. The controlling method according to claim 16, wherein determining the uphill or downhill traveling state of the cycling equipment comprises:
determining that the cycling equipment is in the downhill traveling state upon reception of a downhill state indicating message; and
determining that the cycling equipment is in state other than the downhill traveling state upon reception of a non-downhill state indicating message.

19. The controlling method according to claim 15, wherein determining the uphill or downhill traveling state of the cycling equipment comprises:
obtaining a forward inclination angle of the cycling equipment while traveling; if the forward inclination angle reaches a preset inclination angle, then determining that the cycling equipment is in the downhill traveling state; and if the forward inclination angle does not reach the preset inclination angle, then determining that the cycling equipment is in a state other than the downhill traveling state.

20. The controlling method according to claim 16, wherein determining the uphill or downhill traveling state of the cycling equipment comprises:
obtaining a forward inclination angle of the cycling equipment while traveling; if the forward inclination angle reaches a preset inclination angle, then determining that the cycling equipment is in the downhill traveling state; and if the forward inclination angle does not reach the preset inclination angle, then determining that the cycling equipment is in a state other than the downhill traveling state.
